(19) United States
(12) Patent Application Publication
(10) Pub. No.: US 2025/0168819 A1
(43) Pub. Date: May 22, 2025

(54) VERTICAL POSITIONING METHOD AND SERVER

(71) Applicant: HUAWEI TECHNOLOGIES CO., LTD., Shenzhen (CN)

(72) Inventors: Wenqiang Gao, Xi’an (CN); Qinxin Liu, Shanghai (CN); Jiehua Chen, Shenzhen (CN)

(73) Assignee: HUAWEI TECHNOLOGIES CO., LTD., Shenzhen (CN)

(21) Appl. No.: 19/031,348

(22) Filed: Jan. 18, 2025

Related U.S. Application Data
(63) Continuation of application No. PCT/CN2023/095691, filed on May 23, 2023.

(30) Foreign Application Priority Data
Jul. 26, 2022 (CN) 202210885300.7

(51) Int. Cl. H04W 64/00; H04L 5/00; H04W 24/10; H04W 56/00

(52) U.S. Cl. CPC H04W 64/006; H04W 24/10; H04L 5/005; H04W 56/001

(57) ABSTRACT

A vertical positioning method provides a server receives measurement report MR information sent by a base station, where the MR information is reported by a terminal device and obtains engineering parameters of the base station based on the MR information, where the engineering parameters include a cell site height, a base station downtilt, and an antenna azimuth of the base station. The server extracts feature information of the terminal device from the MR information and inputs the feature information of the terminal device and the engineering parameters of the base station into a preset artificial intelligence AI model to predict a first height of the terminal device. The AI model is obtained through training by using engineering parameters of a plurality of base stations and feature information of a plurality of terminal devices as input samples and using a preset height as a label.

### CROSS-REFERENCE TO RELATED APPLICATIONS

This is a continuation of International Application No. PCT/CN2023/095691 filed on May 23, 2023, which claims priority to Chinese Patent Application No. 202210885300.7 filed on Jul. 26, 2022. The disclosures of the aforementioned applications are hereby incorporated by reference in their entireties.

### TECHNICAL FIELD

Disclosed embodiments relate to the field of communication technologies, and in particular, to a vertical positioning method and a server.

### BACKGROUND

With rapid development of mobile internet and wide popularization of intelligent terminals, a telecommunication mobile operator obtains location information of a mobile terminal user through a radio communication network or an external positioning and then provides a value-added service of a corresponding service for the user based on the location information of the mobile terminal. Therefore, a location based service (LBS) has attracted great attention, and a key to implementing the LBS is a positioning technology.

Currently, for vertical positioning on a mobile terminal, a vertical positioning model may be constructed based on an MRCALL signature feature of the mobile terminal (the MRCALL signature feature refers to a proportion of presence of a cell during call of the mobile terminal), a building drive test signature feature (the drive test signature feature refers to a proportion of a cell for a building, and location information of the building corresponds to current location information of the mobile terminal), and height information of the building, and vertical information of a target mobile terminal is measured by using the vertical positioning model.

In the foregoing solution, drive test information of the building (the drive test information includes the proportion of the cell in the building) needs to be constructed based on minimization of drive test (MDT) information, and then global positioning system (GPS) information reported by the mobile terminal is obtained by using an MDT protocol, to obtain bottom information of the building or top information of the building, that is, obtain the MDT information. However, user privacy of the terminal device may be disclosed based on the GPS information. Therefore, the foregoing solution is slowly promoted in terms of an NR standard, and cannot be widely applied at an initial stage and a middle stage of NR network construction.

### SUMMARY

Embodiments of this disclosure provide a vertical positioning method and a server for vertical positioning on a terminal device in a building.

A first aspect of this disclosure provides a vertical positioning method. A server receives measurement report MR information sent by a base station, where the MR information is reported by the terminal device to the base station, and the server obtains engineering parameters of the base station based on the MR information, where the engineering parameters include a cell site height, a base station downtilt, and an antenna azimuth of the base station. Then, the server extracts feature information of the terminal device from the MR information and inputs the feature information of the terminal device and the engineering parameters of the base station into a preset artificial intelligence AI model to predict a first height of the terminal device. The AI model is obtained through training by using engineering parameters of a plurality of base stations and feature information of a plurality of terminal devices as input samples and using a preset height as a label. Therefore, a vertical height of the terminal device is predicted without using the MDT information.

In some implementations, the MR information includes sounding reference signal (SRS) beam information, the feature information includes an SRS beam feature extracted from the SRS beam information, the SRS beam feature includes an SRS beam energy feature, and the SRS beam energy feature is obtained by performing dimensionality reduction on the SRS beam information. In addition or alternatively to the foregoing, the MR information includes synchronization signal block SSB beam information, the feature information includes an SSB beam feature extracted from the SSB beam information, the SSB beam feature includes an SSB beam energy feature, and the SSB beam energy feature is obtained by the terminal device by performing dimensionality reduction on a vector including a plurality of detected RSRPs of each serving cell. In this way, the SRS beam energy feature and the SSB beam energy feature that are used for training the AI model are obtained.

In some implementations, the SRS beam feature further includes at least one of vertical dimension feature information and a total SRS beam energy feature, the vertical dimension feature information is a percentage, in the SRS beam information, of a sum of energy that is of each row of an antenna panel of the base station and that is detected by the terminal device in total energy in the SRS beam information, and the total SRS beam energy feature is a sum of a preset quantity of highest energy values in the SRS beam information. The SSB beam feature further includes an SSB beam sweeping feature and an SSB beam strongest level, where the SSB beam sweeping feature is a quantity of SSBs that are sent by each serving cell and that are obtained by the terminal device through sweeping and the SSB beam strongest level is at least one of strongest levels of SSBs that are sent by a primary serving cell and that are obtained by the terminal device through sweeping. In this way, another SRS beam feature and another SSB beam feature that are used for training the AI model are obtained.

In some implementations, the feature information of the terminal device further includes a vertical angle of arrival vAOA between the terminal device and the base station. The method further includes determination by the server of a main lobe vertical azimuth θ_{beam_v} of the terminal device based on the SRS beam information and the antenna azimuth. The server normalizes reference signal received powers RSRPs or energy values corresponding to the RSRPs in all directions in the SRS beam information to obtain P_{BeamPwr} and the server calculates θ_{beam_v}^{T}×P_{BeamPwr} to obtain the VAOA.

In some implementations, the server determines M pieces of SSB beam information corresponding to the vAOA, where M is a positive integer. The server determines N pieces of SSB beam information of strongest SSB beam signals in the M pieces of SSB beam information, where N is a positive integer less than M. The server calculates an average value of the N pieces of SSB beam information as a reference vector and calculates a similarity between the SSB beam information and the reference vector. The server corrects the vAOA of the terminal device if the similarity is less than a preset value.

For example, correction of the vAOA of the terminal device by the server includes The server subtracting a preset angle from the vAOA to obtain a new vAOA of the terminal device.

In some implementations, the feature information of the terminal device further includes a distance from the terminal device to the base station, and the method further includes the server obtains first location information of the base station and second location information of a building in which the terminal device is located, and estimates the distance from the terminal device to the base station based on the first location information and the second location information.

In some implementations, the feature information of the terminal device further includes a distance from the terminal device to the base station, and the method further includes the server obtains, from the MR information, delay information from the terminal device to the base station and the server estimates the distance from the terminal device to the base station based on the delay information.

In some implementations, the server obtains a height of an anchor terminal device, SSB beam information and/or SRS beam information of the anchor terminal device and the server determines a first similarity between the SSB beam information of the terminal device and the SSB beam information of the anchor terminal device. In addition to or alternatively to the foregoing, the server determines a second similarity between the SRS beam information of the terminal device and the SRS beam information of the anchor terminal device, estimates a second height of the terminal device based on the first similarity and/or the second similarity, and estimates a height of the terminal device based on the first height and the second height. In this way, accuracy of estimating the height of the terminal device is improved.

According to a second aspect, this disclosure provides a server configured to perform the method according to any implementation of the first aspect.

According to a third aspect, this disclosure provides a computer-readable storage medium storing instructions that, when the instructions are run on a computer, the computer is enabled to perform the method according to any one of the first aspect, the second aspect, or the third aspect.

According to a fourth aspect, this disclosure provides a computer program product that includes computer-executable instructions stored in a computer-readable storage medium. At least one processor of a device may read the computer-executable instructions from the computer-readable storage medium. When the at least one processor executes the computer-executable instructions, the device is enabled to implement the method according to any one of the first aspect or the possible implementations of the first aspect.

According to a fifth aspect, this disclosure provides a communication apparatus that includes at least one processor, a memory, and a communication interface. The at least one processor is coupled to the memory and the communication interface. The memory is configured to store instructions that, when executed by the at least one processor, cause the communication interface to communicate with another communication apparatus under control of the at least one processor. Further, when the instructions are executed by the at least one processor, the at least one processor is enabled to perform the method according to any one of the first aspect or the possible implementations of the first aspect.

According to a sixth aspect, an embodiment provides a chip system, where the chip system includes a processor configured to support implementing a function in the first aspect or any one of the possible implementations of the first aspect.

In a possible design, the chip system may further include a memory configured to store program instructions and data. The chip system may include a chip, or may include a chip and another discrete component.

For technical effects brought by any one of the second aspect to the sixth aspect or the possible implementations of the second aspect to the sixth aspect, refer to technical effects brought by the first aspect or the different possible implementations of the first aspect. Details are not described herein again.

### BRIEF DESCRIPTION OF DRAWINGS

FIG. 1 is a diagram of a composition structure of a communication system according to an embodiment of this disclosure;

FIG. 2-1 is a schematic flowchart of a vertical positioning method according to an embodiment of this disclosure;

FIG. 2-2 is a diagram of an embodiment in which a terminal device feeds back MR information to a base station according to an embodiment of this disclosure;

FIG. 2-3 is a diagram of an embodiment in which a terminal device detects SRS beam information according to an embodiment of this disclosure;

FIG. 2-4 is a diagram of an embodiment in which a vAOA of a terminal device is flipped according to an embodiment of this disclosure;

FIG. 2-5 is a diagram of an embodiment of training an AI model according to an embodiment of this disclosure;

FIG. 2-6 is a diagram of an embodiment of estimating a height of a terminal device according to an embodiment of this disclosure;

FIG. 2-7 is a diagram of an embodiment in which a height of a terminal device is positioned twice according to an embodiment of this disclosure;

FIG. 2-8 is an energy diagram obtained by detecting a beam of a base station by a terminal device according to an embodiment of this disclosure;

FIG. 3 is a diagram of a structure of a server according to an embodiment of this disclosure; and

FIG. 4 is a diagram of a structure of a communication apparatus according to an embodiment of this disclosure.

### DESCRIPTION OF EMBODIMENTS

Disclosed embodiments provide a vertical positioning method and a related device for vertical positioning on a terminal device in a building.

The following specification describes embodiments with reference to the accompanying drawings.

In the specification, claims, and accompanying drawings, the terms “first”, “second”, and the like are intended to distinguish between similar objects but do not necessarily indicate a specific order or sequence. It should be understood that the terms used in such a way are interchangeable in proper circumstances, which is merely a choice to describe objects having a same attribute are described in embodiments of this disclosure. In addition, the terms “include”, “contain” and any other variants mean to cover the non-exclusive inclusion so that a process, method, system, product, or device that includes a series of units is not necessarily limited to those units but may include other units not expressly listed or inherent to such a process, method, system, product, or device.

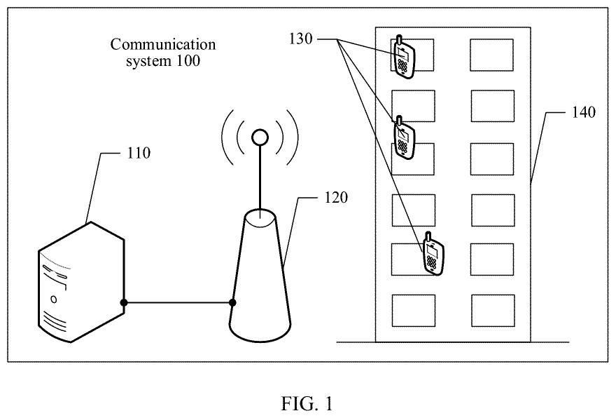

FIG. 1 is a diagram of a composition structure of a communication system according to an embodiment and provides a communication system 100 including a server 110, a base station 120, a plurality of terminal devices 130, and a building 140.

In embodiments of this disclosure, the server 110 may be an independent physical server, a server cluster or a distributed system including a plurality of physical servers, a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In some possible implementations, the server 110 is a network management center. This is not limited herein.

In embodiments of this disclosure, the base station 120 is an access device through which the plurality of terminal devices 130 access the communication system 100 in a wireless manner, for example, a transmission reception point (TRP), a next generation NodeB (gNB) in a 5G mobile communication system, or the like. The base station 120 and the server 110 may be directly or indirectly connected in a wired or wireless communication manner. This is not limited herein.

In embodiments of this disclosure, the terminal device 130 may be referred to as user equipment (UE), a mobile station (MS), a mobile terminal (MT), a mobile phone, a tablet computer (Pad), a computer with a wireless transceiver function, a virtual reality (VR) terminal device, an augmented reality (AR) terminal device, a wireless terminal in industrial control, a wireless terminal in self driving, a wireless terminal in a remote medical surgery, a wireless terminal in a smart grid, a wireless terminal in transportation safety, a wireless terminal in a smart city, a wireless terminal in a smart home, and the like. A specific technology and a specific device form that are used by the terminal device are not limited in embodiments of this disclosure.

The building 140 may be any building of various heights, for example, a middle- and low-rise building below 50 meters or a high-rise building above 50 meters.

Currently, for vertical positioning on a mobile terminal, a vertical positioning model may be constructed based on an MRCALL signature feature of the mobile terminal (the MRCALL signature feature refers to a proportion of presence of a cell during call of the mobile terminal), a building drive test signature feature (the drive test signature feature refers to a proportion of a cell for a building, and location information of the building corresponds to current location information of the mobile terminal), and height information of the building, and vertical information of a target mobile terminal is measured by using the vertical positioning model.

In the foregoing solution, drive test information of the building (the drive test information includes the proportion of the cell for the building) needs to be constructed based on minimization of drive test (MDT) information, and then global positioning system (GPS) information reported by the mobile terminal is obtained by using an MDT protocol to obtain bottom information of the building or top information of the building, a process that is regarded as obtaining the MDT information. However, the GPS information may disclose user privacy of the terminal device. Therefore, the foregoing solution is slowly promoted in an NR standard and cannot be applied in a large scale at an initial stage and a middle stage of NR network construction.

The server receives measurement report MR information sent by a base station, where the MR information is reported by the terminal device to the base station and obtains engineering parameters of the base station based on the MR information, where the engineering parameters include a cell site height, a base station downtilt, and an antenna azimuth of the base station. The server then extracts feature information of the terminal device from the MR information, and inputs the feature information of the terminal device and the engineering parameters of the base station into a preset artificial intelligence AI model, to predict a first height of the terminal device. The AI model is obtained through training by using engineering parameters of a plurality of base stations and feature information of a plurality of terminal devices as input samples and using a preset height as a label. Therefore, a vertical height of the terminal device is predicted without using the MDT information.

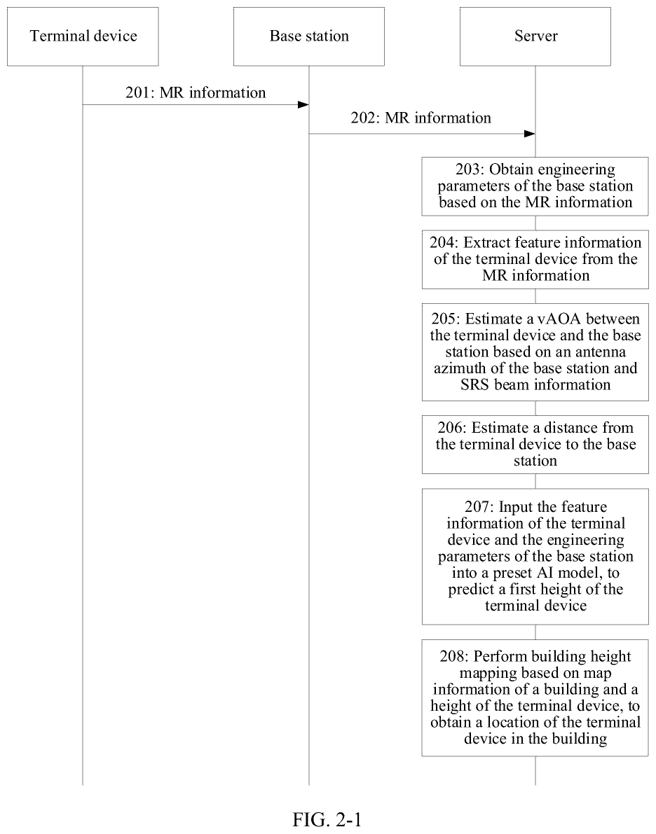

The communication system provided in this disclosure is described in the foregoing embodiment. The following describes a terminal positioning method performed based on the communication system. With reference to FIG. 2-1, the terminal positioning method provided in an embodiment includes the following steps:

201: The terminal device sends measurement report (MR) information to the base station.

It should be noted that the MR information is data sent by the terminal device to the base station every fixed duration (for example, 480 milliseconds or 470 milliseconds) on a service channel between the terminal device and the base station, and the MR information may be used to evaluate and optimize quality of communication between the terminal device and the base station.

In some feasible implementations, as shown in FIG. 2-2, the base station may first send measurement configuration (MC) information to the terminal device, and then the terminal device performs MR measurement based on the MC information to obtain the MR information. The MR information includes a sounding reference signal (SRS) and synchronization signal block (SSB) beam information. Then, the terminal device reports the MR information to the base station.

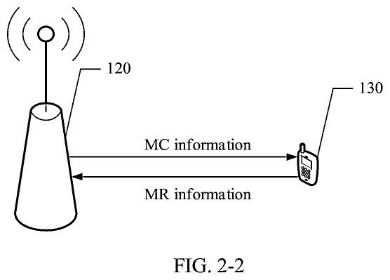

It should be noted that, after receiving the MC information, the terminal device sweeps intra-frequency information periodically broadcast by the base station and records a reference signal received power (RSRP) in each direction as signal strength. For example, as shown in FIG. 2-3, signal strength, namely, a reference signal received power (RSRP), of an antenna panel of a base station detected by the terminal device is used as SRS beam information and is carried in the MR information to be sent to the base station.

202: The base station sends the MR information to the server.

In an embodiment, the base station may forward the MR information to the server.

203: The server obtains the engineering parameters of the base station based on the MR information.

It should be noted that the engineering parameters of the base station include a cell site height (that is, a height of an antenna enclosure mounted in the base station) and a mechanical downtilt and an antenna azimuth of the base station. It should be noted that a data packet that carries the MR information and that is sent by the base station to the server includes cell information of the base station, and the server may query the engineering parameters of the base station based on the cell information of the base station. In some feasible implementations, the cell information of the base station is a cell global identifier (CGI).

204: The server extracts the feature information of the terminal device from the MR information.

In some implementations, the feature information of the terminal device includes an SRS beam feature extracted from the SRS beam information. The SRS beam feature includes an SRS beam energy feature that is obtained by performing dimensionality reduction on the SRS beam information. In addition to or alternatively to the foregoing, the feature information of the terminal device includes an SSB beam feature extracted from the SSB beam information that includes an SSB beam energy feature obtained by the terminal device by performing dimensionality reduction on a vector including a plurality of detected RSRPs of each serving cell.

It should be noted that, after receiving the MR information, the server may obtain the SRS beam information through resolving. For example, the SRS beam information is a 64-dimensional vector, and each element in the vector is an RSRP value. Then, the server may extract feature information in the SRS beam information by using a dimension reduction algorithm (for example, principal component analysis (PCA)), to obtain the SRS beam energy feature.

It should be noted that, after receiving the MR information, the server may obtain the SSB beam information through resolving. For example, the SSB beam information is a plurality of SSBs obtained through sweeping in one primary serving cell and 0 to 8 neighboring cells (a total of nine cells). For example, eight SSBs may be obtained through sweeping in each cell. In this case, the SSB beam information may be 9*8=72 SSBs, that is, a 72-dimensional vector, and each element in the vector is an RSRP value. Then, the server may extract feature information in the SSB beam information by using a dimension reduction algorithm (for example, PCA), to obtain the SSB beam energy feature.

In some implementations, the SRS beam feature further includes at least one of vertical dimension feature information and a total SRS beam energy feature, the vertical dimension feature information is a percentage, in the SRS beam information, of a sum of energy that is of each row of an antenna panel of the base station and that is detected by the terminal device in total energy in the SRS beam information, and the total SRS beam energy feature is a sum of a preset quantity of highest energy values in the SRS beam information.

For example, the terminal device detects that there are four rows and 16 columns of antenna panels of the base station, and the server accumulates RSRP values of each row based on the SRS beam information to obtain four sums of energy (four rows), and then accumulates the four sums of energy to obtain the total energy of the SRS beam information. A four-dimensional vector is obtained by using a ratio of four sums of energy to the total energy of the SRS beam information, and the vector is the vertical dimension feature information.

For example, the total SRS beam energy feature is a sum of 16 highest energy values (that is, highest RSRP values) in the SRS beam information.

In some implementations, the SSB beam feature further includes an SSB beam sweeping feature and an SSB beam strongest level. The SSB beam sweeping feature is a quantity of SSBs that are sent by each serving cell and that are obtained by the terminal device through sweeping, and the SSB beam strongest level is at least one of strongest levels of SSBs that are sent by a primary serving cell and that are obtained by the terminal device through sweeping.

For example, the terminal device obtains three SSBs through sweeping in the primary serving cell, obtains five SSBs through sweeping in one neighboring cell, and obtains no SSBs through sweeping in all other neighboring cells. In this case, an obtained SSB sweeping feature is (3,5,0,0,0,0,0,0,0).

For example, as shown in Table 1, a feature is extracted from the SRS beam information and/or the SSB beam information, to obtain the SRS beam feature and/or the SSB beam feature.

TABLE 1

| Feature | | Feature |
|---|---|---|
| information | Include | source |
| SRS beam | 1. SRS beam energy feature | SRS beam |
| feature | 2. Vertical dimension feature information | information |
| | 3. Total SRS beam energy feature | |
| SSB beam | 1. SSB beam energy feature | SSB beam |
| feature | 2. SSB beam sweeping feature | information |
| | 3. SSB beam strongest level | |

205: The server estimates a vAOA between the terminal device and the base station based on the antenna azimuth of the base station and the SRS beam information.

In some implementations, the feature information of the terminal device further includes an AOA from the terminal device to the base station. In this case, the server may estimate the vAOA between the terminal device and the base station based on the antenna azimuth of the base station and the SRS beam information.

For example, the server determines a main lobe vertical azimuth θ_{beam_v}^{T} of the terminal device based on the SRS beam information and the antenna azimuth, then normalizes reference signal received powers RSRPs or energy values corresponding to the RSRPs in all directions in the SRS beam information, to obtain P_{BeamPwr}, and finally calculates θ_{beam_v}^{T}×P_{BeamPwr}, to obtain the vAOA.

θ_{beam_h}^{T} represents a horizontal azimuth of a beam main lobe detected by the terminal device, and a specific angle may be determined with reference to an antenna pattern of the base station and the SRS beam information. P_{BeamPwr} indicates that the RSRPs or the energy values BeamRsrp corresponding to the RSRPs in all the directions in the SRS beam information are normalized to obtain:

P_{BeamPwr}=10\hat{ }(BeamRsrp/10)

It should be noted that, in a scenario in which the terminal device is located in a high-rise building, an error may occur in the vAOA of the terminal device. For example, as shown in FIG. 2-4, in a case of coverage of a same base station, because a building is close to the base station, a main lobe beam covers a lower part of the building, and a side lobe beam covers an upper part of the building. If terminal device A is covered by the main lobe beam, and terminal device B is covered by the side lobe beam, detected vAOA (a) of terminal device A under the coverage of the side lobe beam is the same as detected vAOA (b) of terminal device B under the coverage of the side lobe beam.

In this case, the server may determine M pieces of SSB beam information corresponding to the vAOA, where M is a positive integer, determine N pieces of SSB beam information of strongest SSB beam signals in the M pieces of SSB beam information, where N is a positive integer less than M, and calculate an average value of the N pieces of SSB beam information as a reference vector. Finally, the server calculates a similarity (for example, a cosine similarity) between the SSB beam information and the reference vector. If the similarity is less than a preset value, the vAOA of the terminal device is corrected. In some possible implementations, the server may subtract a preset angle (for example, 30°) from the vAOA to obtain a new vAOA of the terminal device.

For example, the server may adjust the vAOA of the terminal device by using the following formula:

f(vAoa,SSB_Beam)=Vaoa_adjust

SSB_Beam represents the SSB beam information, Vaoa_adjust represents a calibrated vAOA of the terminal device, and f( ) is used to calculate a function model of an adjustment result based on the vAOA of the terminal device and SSB_Beam. In some feasible implementations, f( ) may be used to calculate a cosine similarity between SSB_Beams corresponding to the vAOA of the terminal device. If the cosine similarity is less than the preset value, the vAOA returned from f( ) to the terminal device is equal to the detected vAOA minus a preset degree, for example, 30°.

206: The server estimates a distance from the terminal device to the base station.

In some possible implementations, the server may obtain first location information of the base station, obtain second location information of a building in which the terminal device is located, and estimate the distance from the terminal device to the base station based on the first location information and the second location information. In some possible implementations, the server may obtain, from the MR information, delay information from the terminal device to the base station, and estimate the distance from the terminal device to the base station based on the delay information, for example, multiply a delay value in the delay information by 4.88 meters/millisecond.

207: The server inputs the feature information of the terminal device and the engineering parameters of the base station into a preset AI model, to predict the first height of the terminal device.

In an embodiment, the AI model is obtained through training by using engineering parameters of a plurality of base stations and feature information of a plurality of terminal devices as input samples and using a preset height as a label.

For example, Table 2 shows information that the server needs to input into the AI model.

TABLE 2

| Feature | | Feature |
|---|---|---|
| information | Include | source |
| SRS beam | 1. SRS beam energy feature (mandatory) | SRS beam |
| feature | 2. Vertical dimension feature information | information |
| | 3. Total SRS beam energy feature | |
| SSB beam | 1. SSB beam energy feature (mandatory) | SSB beam |
| feature | 2. SSB beam sweeping feature | information |
| | 3. SSB beam strongest level | |
| Engineering | 1. Cell site height | Engineering |
| parameters | 2. Base station downtilt | parameters |
| (mandatory) | 3. Antenna azimuth | |
| Other | 1. vAOA between the terminal device | SRS beam |
| feature | and the base station | information |
| information | 2. Distance between the terminal | and |
| | device and the base station | engineering |
| | | parameters |

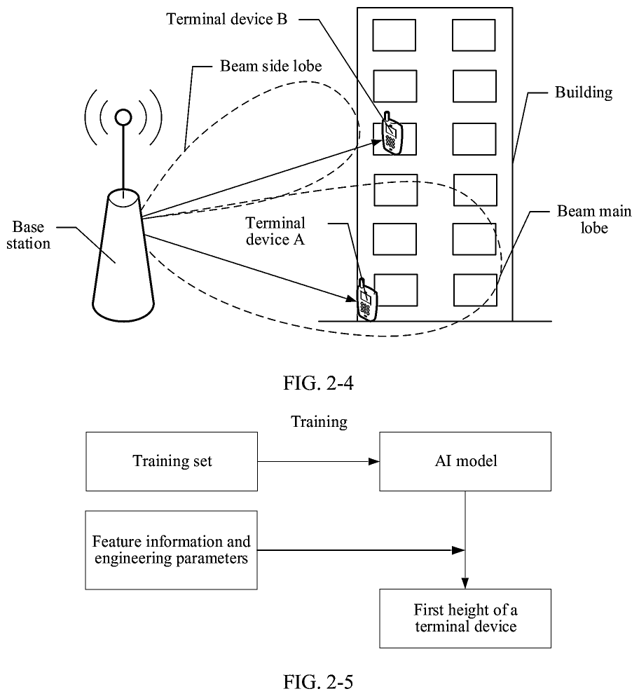

For example, as shown in FIG. 2-5, the server first uses the foregoing information (input sample) and a corresponding height (label) as a training set and inputs an AI model with an initial parameter for training, to obtain the AI model.

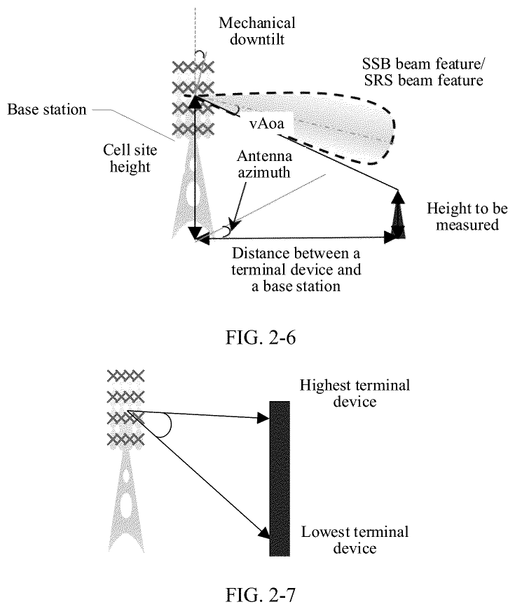

Then, as shown in FIG. 2-6, the server performs vertical positioning on the terminal device based on the SSB beam feature and/or the SRS beam feature, the cell site height, the mechanical downtilt, and the antenna azimuth of the base station, and/or the vAOA between the terminal device and the base station, and the distance from the terminal device to the base station, to obtain the first height of the terminal device.

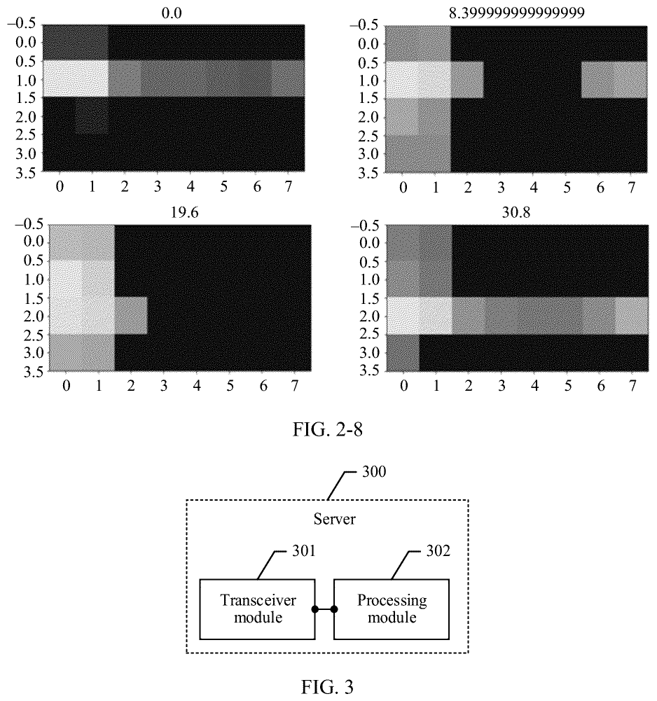

It should be noted that, as shown in FIG. 2-7, when different terminal devices are at different vertical locations in a building, SRS beam information or SSB beam information of the terminal devices is greatly different. For example, when terminal device A is in location A of a building, and terminal device B is in location B of the building, SRS beam information of terminal device A differs greatly from SRS beam information of terminal device B, and SSB beam information of terminal device A differs greatly from SSB beam information of terminal device B. Therefore, vertical positioning on the terminal device may be improved by using these differences.

For example, the server obtains a height of an anchor terminal device, and obtains SSB beam information and/or SRS beam information of the anchor terminal device, and then determines a first similarity between the SSB beam information of the terminal device and the SSB beam information of the anchor terminal device; and/or the server determines a second similarity between the SRS beam information of the terminal device and the SRS beam information of the anchor terminal device. Finally, the server estimates a second height of the terminal device based on the first similarity and/or the second similarity and estimates a height of the terminal device based on the first height and the second height. In some feasible implementations, the server may calculate an average value of the first height and the second height and use the average value as the height of the terminal device.

208: The server performs building height mapping based on map information of the building and the height of the terminal device, to obtain a location of the terminal device in the building.

It should be noted that the map information may be obtained by manually measuring the building on site and preset in the server or may be obtained by a developer or a relevant department of the building, which is not limited herein.

For example, the server determines a height of each floor in the building based on the map information. For example, in a building, heights of floors 1, 4, 7, and 10 are 0 m, 8.4 m, 19.6 m, and 30.8 m, respectively. Then, the server maps the vertical location of the terminal device in the building to the map information, to obtain a floor corresponding to the terminal device in the building. For example, it is determined that the height of the terminal device is 19.6 meters, and the floor corresponding to the terminal device in the building is a third floor. In some feasible implementations, the location in the building may also be displayed as a location percentage of the building. For example, if a height of a building is 50 meters, and a height of a terminal device is 40 meters, a location of the building is 80%.

It should be noted that, after determining the height of the terminal device, the server may send height information of the terminal device to the terminal device or send the height information of the terminal device to an authorized service provider. This is not limited herein.

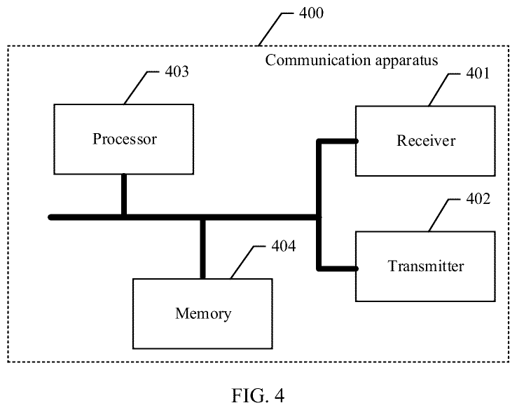

For example, as shown in FIG. 2-8, the server may obtain, through detection, energy diagrams obtained by performing beam detection on the base station by the terminal device at 0 m, 8.4 m, 19.6 m, and 30.8 m, where a lighter-colored location indicates higher energy.

For example, according to multi-site data verification, in the technical solution of this application, an average error of height prediction results of the terminal device for buildings less than 100 meters is less than 6 meters@67%.

It should be noted that, for brief description, the foregoing method embodiments are represented as a series of actions. However, a person skilled in the art should appreciate that this disclosure is not limited to the described order of the actions as some steps may be performed in different orders or simultaneously. It should be further appreciated by a person skilled in the art that described embodiments all belong to example embodiments, and the involved actions and modules are not required.

To better implement the solutions of disclosed embodiments, a related apparatus for implementing the solutions is further provided below.

Referring to FIG. 3, a server 300 provided in accordance with an embodiment of this disclosure may include a transceiver module 301 configured to receive measurement report MR information sent by a base station, where the MR information is reported by a terminal device to the base station; and a processing module 302 configured to obtain engineering parameters of the base station based on the MR information, where the engineering parameters include a cell site height, a base station downtilt, and an antenna azimuth of the base station. The processing module 302 is further configured to extract feature information of the terminal device from the MR information; the processing module 302 is further configured to input the feature information of the terminal device and the engineering parameters of the base station into a preset artificial intelligence AI model, to predict a first height of the terminal device; and the AI model is obtained through training by using engineering parameters of a plurality of base stations and feature information of a plurality of terminal devices as input samples and using a preset height as a label.

In some implementations, the MR information includes sounding reference signal SRS beam information, the feature information includes an SRS beam feature extracted from the SRS beam information, the SRS beam feature includes an SRS beam energy feature, and the SRS beam energy feature is obtained by performing dimensionality reduction on the SRS beam information; and/or the MR information includes synchronization signal block SSB beam information, the feature information includes an SSB beam feature extracted from the SSB beam information, the SSB beam feature includes an SSB beam energy feature, and the SSB beam energy feature is obtained by the terminal device by performing dimensionality reduction on a vector including a plurality of detected RSRPs of each serving cell.

In some implementations, the SRS beam feature further includes at least one of vertical dimension feature information and a total SRS beam energy feature, the vertical dimension feature information is a percentage, in the SRS beam information, of a sum of energy that is of each row of an antenna panel of the base station and that is detected by the terminal device in total energy in the SRS beam information, and the total SRS beam energy feature is a sum of a preset quantity of highest energy values in the SRS beam information; and the SSB beam feature further includes an SSB beam sweeping feature and an SSB beam strongest level, the SSB beam sweeping feature is a quantity of SSBs that are sent by each serving cell and that are obtained by the terminal device through sweeping, and the SSB beam strongest level is at least one of strongest levels of SSBs that are sent by a primary serving cell and that are obtained by the terminal device through sweeping.

In some implementations, the feature information of the terminal device further includes a vertical angle of arrival vAOA between the terminal device and the base station; and the processing module 302 is further configured to: determine a main lobe vertical azimuth θ_{beam_v}^{T} of the terminal device based on the SRS beam information and the antenna azimuth, normalize reference signal received powers RSRPs or energy values corresponding to the RSRPs in all directions in the SRS beam information, to obtain P_{BeamPwr}, and calculate θ_{beam_v}^{T}×P_{BeamPwr}, to obtain the vAOA.

In some implementations, the processing module 302 is further configured to determine M pieces of SSB beam information corresponding to the vAOA, where M is a positive integer; determine N pieces of SSB beam information of strongest SSB beam signals in the M pieces of SSB beam information, where N is a positive integer less than M; calculate an average value of the N pieces of SSB beam information as a reference vector; calculate a similarity between the SSB beam information and the reference vector; and correct the vAOA of the terminal device if the similarity is less than a preset value.

In some implementations, the processing module 302 is configured to subtract a preset angle from the vAOA, to obtain a new vAOA of the terminal device.

In some implementations, the processing module 302 is further configured to obtain first location information of the base station, obtain second location information of a building in which the terminal device is located, and estimate a distance from the terminal device to the base station based on the first location information and the second location information.

In some implementations, the feature information of the terminal device further includes a distance from the terminal device to the base station, and the processing module 302 is configured to: obtain, from the MR information, delay information from the terminal device to the base station; and estimate the distance from the terminal device to the base station based on the delay information.

In some implementations, the processing module 302 is configured to obtain a height of an anchor terminal device, obtain SSB beam information and/or SRS beam information of the anchor terminal device, determine a first similarity between the SSB beam information of the terminal device and the SSB beam information of the anchor terminal device; and/or determine, by the server, a second similarity between the SRS beam information of the terminal device and the SRS beam information of the anchor terminal device, estimate a second height of the terminal device based on the first similarity and/or the second similarity, and estimate a height of the terminal device based on the first height and the second height.

It should be noted that, because content such as information exchange between the modules/units of the apparatus and the execution processes thereof is based on the same concept as method embodiments of this disclosure, technical effects brought are the same as those of the method embodiments described above. For specific content, refer to the descriptions in the foregoing method embodiments. Details are not described herein again.

An embodiment further provides a computer storage medium that stores a program. The program is executed to perform some or all of the steps recited above in the method embodiments.

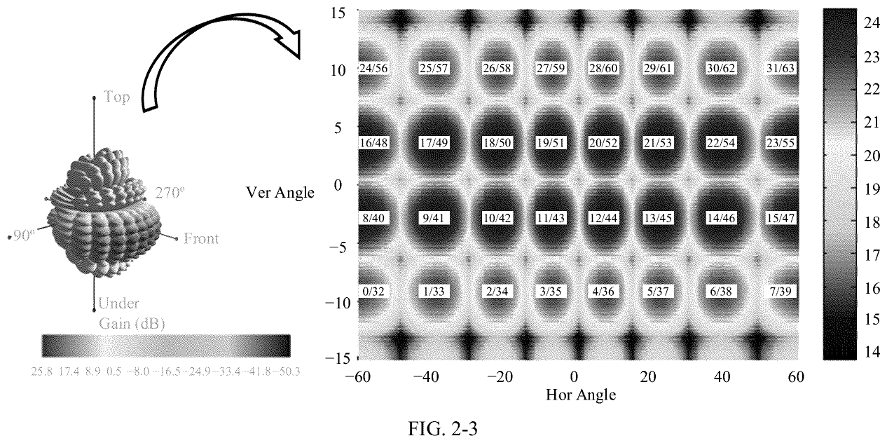

The following describes another communication apparatus according to an embodiment of this disclosure. Referring to FIG. 4, a communication apparatus 400 includes a receiver 401, a transmitter 402, a processor 403, and a memory 404. In some embodiments, the receiver 401, the transmitter 402, the processor 403, and the memory 404 may be connected through a bus or in another manner, and an example in which the bus is used for connection is described in FIG. 4.

The memory 404 may include a read-only memory and a random access memory, and provide instructions and data to the processor 403. A part of the memory 404 may further include a non-volatile random access memory (NVRAM). The memory 404 stores an operating system and an operation instruction, an executable module, or a data structure, or a subset thereof, or an extended set thereof. The operation instruction may include various operation instructions used to implement various operations. The operating system may include various system programs, to implement various basic services and process a hardware-based task.

The processor 403 controls an operation of the communication apparatus 400, and the processor 403 may also be referred to as a central processing unit (CPU). In a specific application, components of the communication apparatus 400 are coupled together by using a bus system. In addition to a data bus, the bus system may include a power supply bus, a control bus, a status signal bus, and the like. However, for clear description, various types of buses in the figure are marked as the bus system.

The method described in embodiments of this disclosure may be applied to the processor 403 or may be implemented by the processor 403. The processor 403 may be an integrated circuit chip having signal processing capability. In an implementation process, steps in the method may be implemented by using a hardware integrated logical circuit in the processor 403, or by using instructions in the form of software. The processor 403 may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor 403 may implement or perform the methods, the steps, and logical block diagrams that are disclosed in embodiments of this disclosure. The general-purpose processor may be a microprocessor, or the processor may be any conventional processor or the like. The steps in the methods disclosed with reference to disclosed embodiments may be directly performed and completed by a hardware decoding processor or may be performed and completed by using a combination of hardware in the decoding processor and a software module. A software module may be located in a mature storage medium in the art, such as a random access memory, a flash memory, a read-only memory, a programmable read-only memory, an electrically erasable programmable memory, or a register. The storage medium is located in the memory 404, and the processor 403 reads information in the memory 404 and completes the steps of the foregoing methods in combination with hardware of the processor 403.

The receiver 401 may be configured to receive input digit or character information and generate a signal input related to a related setting and function control. The transmitter 402 may include a display device like a display. The transmitter 402 may be configured to output digit or character information through an external interface.

In embodiments of this disclosure, the processor 403 is configured to perform the vertical positioning method performed by the server 300.

In another possible design, when the server 300 or the communication apparatus 400 is a chip, the server 300 or the communication apparatus 400 includes a processing unit and a communication unit. The processing unit may be, for example, a processor, and the communication unit may be, for example, an input/output interface, a pin, or a circuit. The processing unit may execute computer-executable instructions stored in a storage unit so that the chip in the terminal performs the wireless report information sending method according to any one of the possible implementations of the first aspect. Optionally, the storage unit is a storage unit in the chip, for example, a register or a buffer. Alternatively, the storage unit may be a storage unit in the terminal but outside the chip, for example, a read-only memory (ROM), another type of static storage device that can store static information and instructions, or a random access memory (RAM).

The processor mentioned anywhere above may be a general-purpose central processing unit, a microprocessor, an ASIC, or one or more integrated circuits configured to control program execution of the methods.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected according to actual needs to achieve the objectives of the solutions of embodiments. In addition, in the accompanying drawings of the apparatus embodiments provided in this application, connection relationships between modules indicate that the modules have communication connections with each other, which may be implemented as one or more communication buses or signal cables.

Based on the descriptions in the foregoing implementations, a person skilled in the art may clearly understand that disclosed embodiments may be implemented by using software in addition to necessary general-purpose hardware, or by using special-purpose hardware, including an application-specific integrated circuit, a dedicated CPU, a dedicated memory, a dedicated element or component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this disclosure may be partially or entirely implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a server, or a network device) to perform the methods described in embodiments of this disclosure.

All or some of the foregoing embodiments may be implemented by using software, hardware, firmware, or any combination thereof. When software is used to implement embodiments, all or a part of embodiments may be implemented in a form of a computer program product.

The computer program product includes one or more computer instructions. When the computer program instructions are loaded and executed on the computer, the procedure or functions according to disclosed embodiments of this application are all or partially generated. The computer may be a general purpose computer, a dedicated computer, a computer network, or other programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible to a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

1. A vertical positioning method, comprising:
receiving, by a server, measurement report (MR) information sent by a base station, wherein the MR information is reported by a terminal device to the base station;
obtaining, by the server, engineering parameters of the base station based on the MR information, wherein the engineering parameters comprise base station cell site height, base station downtilt, and base station antenna azimuth;
extracting, by the server, feature information of the terminal device from the MR information; and
inputting, by the server, the feature information of the terminal device and the engineering parameters of the base station into a preset artificial intelligence (AI) model and running the preset AI model to predict a first height of the terminal device, wherein the AI model is obtained through training by using engineering parameters of a plurality of base stations and feature information of a plurality of terminal devices as input samples and using a preset height as a label.

2. The method according to claim 1, wherein the MR information comprises at least one of:
sounding reference signal (SRS) beam information and the feature information comprises an SRS beam feature extracted by the server from the SRS beam information, the SRS beam feature comprising an SRS beam energy feature obtained by performing dimensionality reduction on the SRS beam information; or
synchronization signal block (SSB) beam information and the feature information comprises an SSB beam feature extracted by the server from the SSB beam information, the SSB beam feature comprising an SSB beam energy feature obtained by the terminal device by performing dimensionality reduction on a vector comprising a plurality of detected reference signal received powers (RSRPs) of each serving cell.

3. The method according to claim 2, wherein:
the SRS beam feature further comprises at least one of vertical dimension feature information or a total SRS beam energy feature, the vertical dimension feature information is a percentage, in the SRS beam information, of a sum of energy that is of each row of an antenna panel of the base station and that is detected by the terminal device in total energy in the SRS beam information, and the total SRS beam energy feature is a sum of a preset quantity of highest energy values in the SRS beam information; and
the SSB beam feature further comprises an SSB beam sweeping feature and an SSB beam strongest level, the SSB beam sweeping feature is a quantity of SSBs that are sent by each serving cell, and the SSB beam strongest level is at least one of strongest levels of SSBs that are sent by a primary serving cell.

4. The method according to claim 1, wherein the feature information of the terminal device further comprises a vertical angle of arrival vAOA between the terminal device and the base station, and the method further comprises:
determining, by the server, a main lobe vertical azimuth θ_{beam_v}^{T} of the terminal device based on the SRS beam information and the antenna azimuth;
normalizing, by the server, reference signal received powers RSRPs or energy values corresponding to the RSRPs in all directions in the SRS beam information, to obtain P_{BeamPwr}; and
calculating, by the server, θ_{beam_v}^{T}×P_{BeamPwr}, to obtain the vAOA.

5. The method according to claim 4, wherein the method further comprises:
determining, by the server, M pieces of SSB beam information corresponding to the vAOA, wherein M is a positive integer;
determining, by the server, N pieces of SSB beam information of strongest SSB beam signals in the M pieces of SSB beam information, wherein N is a positive integer less than M;
calculating, by the server, an average value of the N pieces of SSB beam information as a reference vector;
calculating, by the server, a similarity between the SSB beam information and the reference vector; and
correcting, by the server, the vAOA of the terminal device if the similarity is less than a preset value.

6. The method according to claim 5, wherein the correcting, by the server, the vAOA of the terminal device comprises:
subtracting, by the server, a preset angle from the vAOA to obtain a new vAOA of the terminal device.

7. The method according to claim 1, wherein the feature information of the terminal device further comprises a distance from the terminal device to the base station, and the method further comprises:
obtaining, by the server, first location information of the base station;
obtaining, by the server, second location information of a building in which the terminal device is located; and
estimating, by the server, the distance from the terminal device to the base station based on the first location information and the second location information.

8. The method according to claim 1, wherein the feature information of the terminal device further comprises a distance from the terminal device to the base station, and the method further comprises:
obtaining, by the server from the MR information, delay information from the terminal device to the base station; and
estimating, by the server, the distance from the terminal device to the base station based on the delay information.

9. The method according to claim 1, wherein the method further comprises:
obtaining, by the server, a height of an anchor terminal device;
obtaining, by the server, SSB beam information and/or SRS beam information of the anchor terminal device;
determining, by the server, a first similarity between the SSB beam information of the terminal device and the SSB beam information of the anchor terminal device; and/or determining, by the server, a second similarity between the SRS beam information of the terminal device and the SRS beam information of the anchor terminal device;
estimating, by the server, a second height of the terminal device based on the first similarity and/or the second similarity; and
estimating, by the server, a height of the terminal device based on the first height and the second height.

10. A communication apparatus, comprising:
a communication interface;
at least one processor connected to the communication interface; and
a memory storing instructions connected to the at least one processor through the communication interface that, when the instructions are executed by the at least one processor, cause the communication apparatus to:
receive measurement report (MR) information sent by a base station, wherein the MR information is reported by a terminal device to the base station;
obtain engineering parameters of the base station based on the MR information, wherein the engineering parameters comprise base station cell site height, base station downtilt, and antenna azimuth of the base station,
extract feature information of the terminal device from the MR information; and
input the feature information of the terminal device and the engineering parameters of the base station into a preset artificial intelligence (AI) model and running the preset AI model to predict a first height of the terminal device, wherein the AI model is obtained through training by using engineering parameters of a plurality of base stations and feature information of a plurality of terminal devices as input samples and using a preset height as a label.

11. The communication apparatus according to claim 10, wherein the MR information comprises at least one of:
sounding reference signal (SRS) beam information, the feature information comprises an SRS beam feature extracted from the SRS beam information, the SRS beam feature comprises an SRS beam energy feature obtained by performing dimensionality reduction on the SRS beam information; or
synchronization signal block SSB beam information, the feature information comprises an SSB beam feature extracted from the SSB beam information, the SSB beam feature comprises an SSB beam energy feature obtained by the terminal device by performing dimensionality reduction on a vector comprising a plurality of detected reference signal received powers (RSRPs) of each serving cell.

12. The communication apparatus according to claim 11, wherein:
the SRS beam feature further comprises at least one of vertical dimension feature information and a total SRS beam energy feature, the vertical dimension feature information is a percentage, in the SRS beam information, of a sum of energy of each row of an antenna panel of the base station and that is detected by the terminal device in total energy in the SRS beam information, and the total SRS beam energy feature is a sum of a preset quantity of highest energy values in the SRS beam information; and
the SSB beam feature further comprises an SSB beam sweeping feature and an SSB beam strongest level, the SSB beam sweeping feature is a quantity of SSBs that are sent by each serving cell, and the SSB beam strongest level is at least one of strongest levels of SSBs that are sent by a primary serving cell.

13. The communication apparatus according to claim 10, wherein:
the feature information of the terminal device further comprises a vertical angle of arrival vAOA between the terminal device and the base station; and
execution of the instructions by the at least one processor further cause the communication apparatus to:
determine a main lobe vertical azimuth θ_{beam_v}^{T} of the terminal device based on the SRS beam information and the antenna azimuth, normalize reference signal received powers RSRPs or energy values corresponding to the RSRPs in all directions in the SRS beam information, to obtain P_{BeamPwr}, and calculate θ_{beam_v}^{T}×P_{BeamPwr}, to obtain the vAOA.

14. The communication apparatus according to claim 13, wherein execution of the instructions by the at least one processor further cause the communication apparatus to:
determine M pieces of SSB beam information corresponding to the vAOA, wherein M is a positive integer;
determine N pieces of SSB beam information of strongest SSB beam signals in the M pieces of SSB beam information, wherein N is a positive integer less than M;
calculate an average value of the N pieces of SSB beam information as a reference vector;
calculate a similarity between the SSB beam information and the reference vector; and
correct the vAOA of the terminal device if the similarity is less than a preset value.

15. The communication apparatus according to claim 14, wherein execution of the instructions by the at least one processor further cause the communication apparatus to:
subtract a preset angle from the vAOA, to obtain a new vAOA of the terminal device.

16. The communication apparatus according to claim 10, wherein execution of the instructions by the at least one processor further cause the communication apparatus to:
obtain first location information of the base station;
obtain second location information of a building in which the terminal device is located; and
estimate a distance from the terminal device to the base station based on the first location information and the second location information.

17. The communication apparatus according to claim 10, wherein the feature information of the terminal device further comprises a distance from the terminal device to the base station, and execution of the instructions by the at least one processor further cause the communication apparatus to:
obtain, from the MR information, delay information from the terminal device to the base station; and
estimate the distance from the terminal device to the base station based on the delay information.

18. The communication apparatus according to claim 10, wherein execution of the instructions by the at least one processor further cause the communication apparatus to:
obtain a height of an anchor terminal device;
obtain SSB beam information and/or SRS beam information of the anchor terminal device;
determine a first similarity between the SSB beam information of the terminal device and the SSB beam information of the anchor terminal device and/or determine a second similarity between the SRS beam information of the terminal device and the SRS beam information of the anchor terminal device;
estimate a second height of the terminal device based on the first similarity and/or the second similarity; and
estimate a height of the terminal device based on the first height and the second height.

19. A computer-readable storage medium storing program instructions that enable a computer device to:
receive measurement report (MR) information sent by a base station, wherein the MR information is reported by a terminal device to the base station; and
obtain engineering parameters of the base station based on the MR information, wherein the engineering parameters comprise base station cell site height, base station downtilt, and antenna azimuth of the base station,
extract feature information of the terminal device from the MR information; and
input the feature information of the terminal device and the engineering parameters of the base station into a preset artificial intelligence (AI) model and running the preset AI model to predict a first height of the terminal device, wherein the AI model is obtained through training by using engineering parameters of a plurality of base stations and feature information of a plurality of terminal devices as input samples and using a preset height as a label.

20. The computer-readable storage medium according to claim 19, wherein the MR information comprises at least one of:
sounding reference signal (SRS) beam information, the feature information comprises an SRS beam feature extracted from the SRS beam information, the SRS beam feature comprises an SRS beam energy feature obtained by performing dimensionality reduction on the SRS beam information; or
synchronization signal block SSB beam information, the feature information comprises an SSB beam feature extracted from the SSB beam information, the SSB beam feature comprises an SSB beam energy feature obtained by the terminal device by performing dimensionality reduction on a vector comprising a plurality of detected RSRPs of each serving cell.
